(19) United States
(12) Patent Application Publication
(10) Pub. No.: US 2008/0312001 A1
(43) Pub. Date: Dec. 18, 2008

(54) Rotation Shaft Having Function of Anti-Vibrating

(76) Inventors: Wang-Jui Lee, Sinjhuang City (TW); Chin-Chung Huang, Sinjhuang City (TW); Hua-Feng Hsu, Sinjhuang City (TW); Kun-Yeh Lee, Sinjhuang City (TW); Kuo-Tung Liao, Sinjhuang City (TW); Shao-Chen Tien, Sinjhuang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 12/126,969

(22) Filed: May 26, 2008

(30) Foreign Application Priority Data
Jun. 15, 2007 (TW) 096209854

(51) Int. Cl. F16C 3/00

(52) U.S. Cl. 464/180

(57) ABSTRACT

The present invention presents to a rotation shaft having function of anti-vibrating, comprises a retaining member having a sleeve, an shaft hole is axially formed on the sleeve, a mounting slot is radially extended from the shaft hole, the opening end of the shaft hole is adjacently connected to a concave positioning slot with a concave shape; an inner shaft bushing having at least one hollow clamping ring, a rack sheet is radially extended from one end of the clamping ring, and an opening is formed by the other end of the clamping ring and the rack sheet, the clamping ring and the rack sheet are respectively connected to the shaft hole and the mounting slot; an end sealing sheet, a mounting sheet is radially connected to a ring-shaped sheet of the end dealing sheet for being retained in the opening end of the shaft hole and the concave positioning slot the ring-shaped sheet is axially provided with a through hole located at the opening end of the shaft hole and communicating with the clamping ring; a mobile member, a shaft rod is axially extended from the mobile member and an oil sealing ring having an outer diameter larger than that of the shaft rod is protrudingly provided at the rear portion of the shaft rod, the shaft rod passes through the through hole and is covered by the clamping ring, and the outer diameter of the oil sealing ring is slightly smaller than the inner diameter of the through hole, so the oil sealing ring is provided on the through hole with a non-interfering fashion.

### BACKGROUND OF THE INVENTION

1. Field of the Invention

The present invention relates to a rotation shaft more particularly to a rotation shaft having function of anti-vibrating.

2. Description of Related Art

For commercial electronic goods, e.g. a portable computer a mobile phone, an electronic dictionary and a portable audio/video playing device, etc its main portion is mostly disposed below its cover and a rotation shaft is provided to connected the main portion and the cover, so the cover can be opened or closed, relative to the main portion, therefore the rotation shaft plays an crucial role on determining the quality of the goods mentioned above.

The Taiwan Patent No. 420321 has disclosed an invention titled in ‘Structure of bi-directional positioning hinge”. The retaining seat of the hinge is made of metal casting, in order to increase the feature of wearing-resistance, a jointing hole is axially provided on the retaining seat and the end section of the jointing hole is connected to a H-shaped slot for inserting a plurality of tube struts into the jointing hole, and an end section formed by arranging the bases of the tube struts with an interval is positioned in the H-shaped slot. A shaft rod of a pivotal shaft passes through shaft holes provided at the center of the tube struts so a hinge structure is obtained. The connection between the retaining seat of the hinge and the tube struts has provided a retaining fashion for a soft metal casting and hard tube struts.

In order to prevent lubricating oil provided between the tube struts and the shaft rod from leaking or oozing, the leak or the ooze will cause contamination or let the pivotal rotation of the rotation shaft be effected. The tube struts are made by bending metal so the transversal holes thereon are not in a real round shape, when the shaft rod of the pivotal shaft rotates within the holes of the tube struts, vibration is generated so the wearing between the two components is increased.

The Taiwan Patent No. M296583 has disclosed a hinge, the hinge includes a retaining seat having a jointing hole, a tube strut, a pivotal shaft that passes through the tube strut and is disposed in the jointing hole of the retaining seat together with the tube strut; wherein the pivotal shaft is provided with a sealing sheet, the outer end of the sealing sheet is provided with a positioning block, the center of the sealing sheet has a through hole which is used to let the pivotal shaft pass through, the inner diameter of the through hole is not larger than the outer diameter of the pivotal shaft, the opening end of the jointing hole of the retaining seat is provided with a positioning slot for receiving the positioning block of the sealing sheet of the pivotal shaft. After the sealing sheet is mounted in the jointing hole of the retaining sheet, lubricating oil is prevented from leaking. The inner diameter of the round-shaped through hole is not larger than the outer diameter of the pivotal shaft, in other words the inner diameter of the through hole is smaller or equal to the outer diameter of the pivotal shaft, so when the two components are processed with a sleeve operation, the through hole can be served to tighten the pivotal shaft so as to prevent the components from vibrating. The disadvantages of this patent is (1) because the inner diameter of the through hole of the seating sheet is smaller or equal to the outer diameter of the pivotal shaft and the through hole is not resilient, the jointing fashion between the two components is therefore by tightening, this often causes the surface of the whole rotation shaft wear; (2) effects of interfering or over-tightening may be formed between the through hole and the pivotal shaft, so the contact area between the through hole and the pivotal shaft is significantly worn thus the contact area between the through hole and the pivotal shaft become thinner, so the torque is varied and become smaller, and the whole torque of the hinge is effected; and (3) the positioning block protruded from the periphery of the sealing sheet has to mate the positioning slot of retaining seat that is correspondingly provided so the precision between the two components is so great that the assembly is more difficult.

### SUMMARY OF THE INVENTION

The applicant of the present invention has, for years, devoted himself to design and commercially distribute rotation shaft, and wishes to overcome problems caused by the inner diameter of the through hole of the seating sheet is not larger than the outer diameter of the pivotal shaft in the hinge mentioned above, and to overcome problems that the tightness between the retaining seat and the sealing sheet is not good enough therefore the assembly is difficult; the applicant has been trying to use at least one end sealing sheet provided on the opening end of the shaft hole of the retaining seat, and the end sealing sheet is tightly connected on the outer end of the shaft hole so the two components are not easy to be separated, thus the effect of anti-vibrating is achieved; after time and efforts, the present invention “Rotation shaft having function of anti-vibrating” is provided.

In order to achieve the objects mentioned above, the present invention provides a rotation shaft having function of anti-vibrating, comprises a retaining member having a sleeve, an shaft hole is axially formed on the sleeve, a mounting slot is radially extended from the shaft hole, the opening end of the shaft hole is adjacently connected to a concave positioning slot with a concave shape;

an inner shaft bushing having at least one hollow clamping ring, a rack sheet is radially extended from one end of the clamping ring, and an opening is formed by the other end of the clamping ring and the rack sheet, the clamping ring and the rack sheet are respectively connected to the shaft hole and the mounting slot;

an end sealing sheet, a mounting sheet is radially connected to a ring-shaped sheet of the end dealing sheet for being retained in the opening end of the shaft hole and the concave positioning slot, the ring-shaped sheet is axially provided with a through hole located at the opening end of the shaft hole and communicating with the clamping ring; a mobile member, a shaft rod is axially extended from the mobile member and an oil sealing ring having an outer diameter larger than that of the shaft rod is protrudingly provided at the rear portion of the shaft rod the shaft rod passes through the through hole and is covered by the clamping ring, and the outer diameter of the oil sealing ring is slightly smaller than the inner diameter of the through hole, so the oil sealing ring is provided on the through hole with a non-interfering fashion.

Another object of the present invention is to provided a rotation shaft having function of anti-vibrating, wherein the lateral end of the mounting slot is provided with at least one latching slot, and a latching tenon is provided on the surface of the rack sheet with respect to each location of the latching slot so the rack sheet can be latched by the latching slot.

One another object of the present invention is to provide a rotation shaft having function of anti-vibrating, wherein a connecting section is provided on the retaining member, an engaging section is provided on the mobile member, the connecting section and the engaging section are respectively provided with a jointing hole, the connecting section is a milling face column or a polygonal prism, and the engaging section is a milling face column or a polygonal prism.

One another object of the present invention is to provide a rotation shaft having function of anti-vibrating, wherein the inner shaft bushing is cut by at least one rip slot and at least two clamping rings are formed, the directions of the openings between the to clamping rings and the rack sheet can be the same or opposite.

One another object of the present invention is to provide a rotation shaft having function of anti-vibrating, wherein the periphery of the end sealing sheet is provided with a plurality of protruding sections that slightly protrude, an interfere is formed between the protruding sections and the inner wall of the shaft hole so the end sealing sheet is fixed in the shaft hole.

One another object of the present invention is to provide a rotation shaft having function of anti-vibrating, wherein the surface of the rack sheet of the inner shaft bushing is provided with at least one tenon slot/hole, the surface of the retaining member is punched by a jig with respect to the locations of the tenon slots/holes, so at least one concave section is formed on the surface of the retaining member, and the deformed material is completely filled in each of the tenon slot/hole, so a protruding tenon having a column/strip shape is formed.

One another object of the present invention is to provide a rotation shaft having function of anti-vibrating, wherein at least one end of the concave positioning slot is protrudingly provided with at least one connecting slot, and the mounting sheet is protrudingly provided with a connecting pin with respect to the location of each connecting slot so each connecting pin is latched and received in the corresponding connecting slot.

One another object of the present invention is to provide a rotation shaft having function of anti-vibrating, wherein the inner end of the oil sealing ring of the shaft rod adjacent to the through hole is provided with a concave oil storing tank.

### BRIEF DESCRIPTION OF THE DRAWINGS

FIG. 1 is a 3D exploded view of the rotation shaft provided by the present invention;

FIG. 2 is a 3D exploded view of the rotation shaft provided by the present invention, from a different viewing angle;

FIG. 3 is a 3D view of the rotation shaft provided by the present invention, after assembled;

FIG. 4 is a cross sectional view of FIG. 3 intercepted alongside an A-A line,

FIG. 4A is a cross section and partial enlarged view of the shaft rod, the end sealing sheet and the inner shaft bushing provided by the present invention.

### DETAILED DESCRIPTION OF THE PREFERRED EMBODIMENT

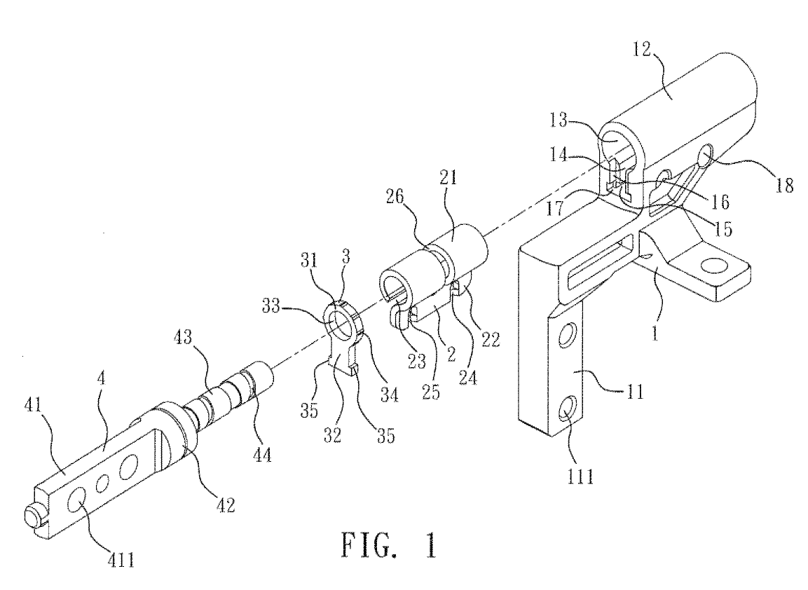

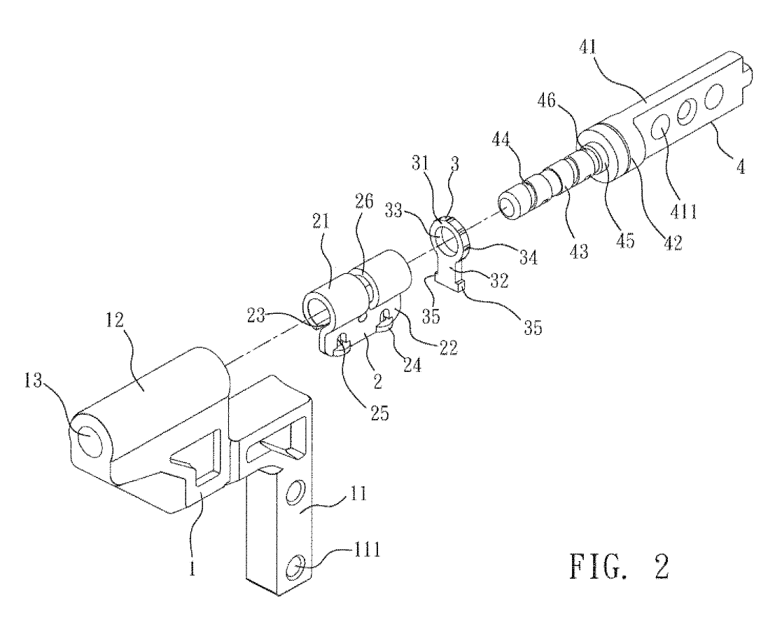

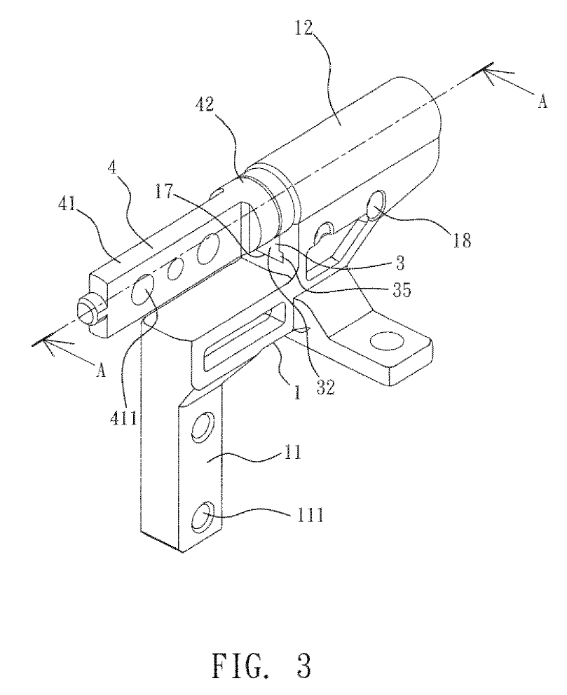

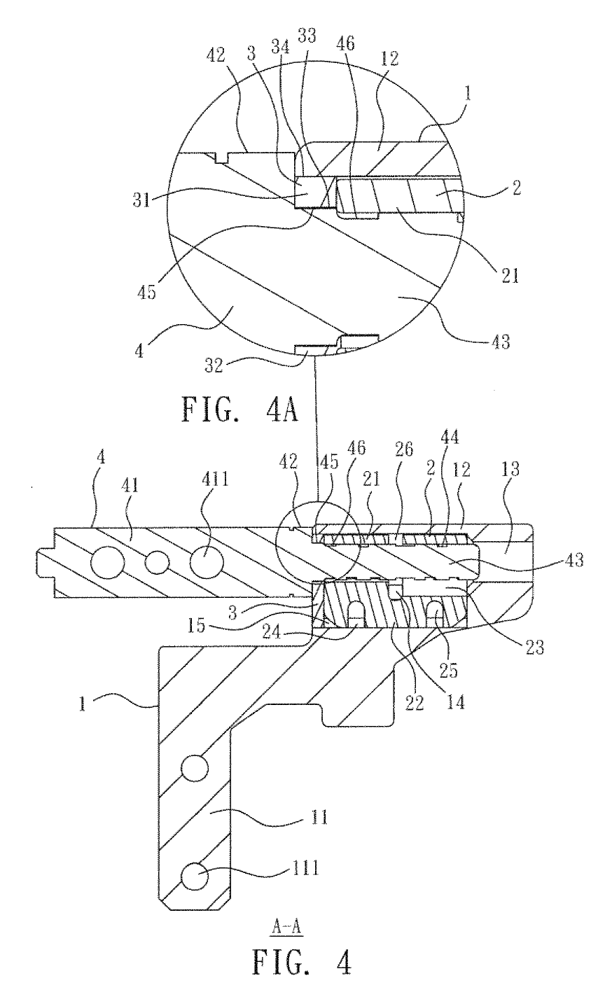

As shown in FIG. 1 to FIG. 4, the rotation shaft provided by the present invention is substantially composed by a retaining member 1, an inner shaft bushing 2, an end sealing sheet 3 and a mobile member 4; wherein the terms “retaining” and “mobile”, mentioned above are not used to limit the operation status or operation fashion of the retaining member 1 and the mobile member 4. When operating, the mobile member 4 can be kept in a fixed status and the retaining member 1 rotates instead.

The retaining member 1 is a soft metal, e.g. a seat member made of a zinc alloy after cast and punched. The retaining member 1 has at least one connecting section 11 for connecting to an object, e.g. a main portion of a notebook computer; as shown in figures, the connecting section 11 has at least one jointing hole 111 that can be fixed on an object by a conventional jointing member, e.g. a screw. The connecting section 11 is, not but limited to, a milling face column, a polygonal prism such as a triangle prism or a tetragon prism, so the connecting section 11 can be inserted and mounted on an object.

A sleeve 12 is extended from one end of the connecting section 11, a shaft hole 13 is axially provided thereon, the shaft hole 13 is radially connected to a mounting slot 14, and a latching slot 15 communicating with the mounting slot 14 is horizontally extended below the mounting slot 14. The feature of the retaining member 1 is a concave positioning slot 16 served to connect to an end sealing sheet 3 is provided below the shaft hole 13 and in front of the mounting slot 14, wherein a connecting slot 17 is horizontally extended from at least one end of the concave positioning slot 16; as shown in figures, in this embodiment a pair of the connecting slot 17 are horizontally extended from the concave positioning slot 16 for forming a better connecting and positioning relationship with the end sealing sheet 3.

The inner shaft bushing 2 is a bended rack member, a rack sheet 22 is radially extended from one end (fixed end) of at least one hollow clamping ring 21, an opening 23 is provided by the other end (mobile end) of the hollow claming ring 21 and the rack sheet 22 so the clamping ring 21 is provided with a function of elastically retracting. As shown in figures, the inner shaft bushing 2 is cut by a rip slot 26 so two clamping rings 21 are formed, the directions of the openings 23 between the two clamping rings 21 and the rack sheet 22 can be the same or opposite. When the inner shaft bushing 2 is desired to be connected to the retaining member 1, the claming ring 21 and the rack sheet 22 of the inner shaft bushing 2 are aimed to the shaft hole 13 and the mounting slot 14 then the inner shaft bushing 2 is inserted to the retaining member 1.

At least one latching tenon 24 is punched and formed on a surface of the rack sheet 22, the latching tenon 24 is connected to the latching slot 15 laterally communicating with the mounting slot 14, so the inner shaft bushing 2 would not be driven to longitudinally move by the rotation of the mobile member 4. In order to let the inner shaft bushing 2 stably connects to the retaining member 1, at least one tenon slot/hole 25 is provide on the surface of the rack sheet 22, as shown in figures the tenon hole 25 is provided below each of the clamping ring 21. After the inner shaft bushing 2 is inserted to the sleeve 12 of the retaining member 1, the surface of the retaining member 1 is punched by a jig with respect to the locations of the tenon slots/holes 25, so a concave section 18 is formed on the surface of the retaining member 1, and the deformed material is completely filled into each tenon slot/hole 25, thus a protruding tenon having a column/strip shape is formed, so that the positioning between the inner shaft bushing 2 and the retaining member 1 is ensured and the inner shaft bushing 2 and the retaining member 1 are protected from breaking by an external axial force.

The end sealing sheet 3 is a sheet member having a shape of a lock hole, and a ring-shaped sheet 31 is provided thereon, and a mounting sheet 32 is radially extended from the end sealing sheet 3 for mounting the shaft hole 13 and the concave positioning slot 16 disposed below the shaft hole 13, a through hole 33 is axially provided on the ring-shaped sheet 31, and the inner diameter of the through hole 33 is larger than an outer diameter of a shaft rod 43, so after the shaft rod 43 passes though the through hole 33 the shaft rod 43 is clamped by at least one clamping ring 21 thus an interfere is formed. In order to let the ring-shaped sheet 31 stably connect to the inside of the shaft hole 13, the periphery of the ring-shaped sheets 31 is provided with a plurality of protruding sections 34 that slightly protrude, so an interfere is formed between the protruding sections 34 and the inner wall of the shaft hole 13, so the ring-shaped sheet 31 would not release from the shaft hole 13. Two ends of the mounting sheet 32 are respectively and protrudingly provided with a connecting pin 35 for respectively latching and receiving in the connecting slot 17.

The mobile member 4 is a rod member, an engaging section 41 provided on one end of the mobile member 4 is connected to another object, e.g. a supporting rack, so the mobile member 4 can be connected to a cover member of a notebook computer; as shown in figures at least one jointing hole 411 is provided on the engaging section 41, so a rivet, an example of a conventional jointing member, can be used to pass though a rack hole pre-set on the supporting rack and the jointing hole 411, then the rivet is riveted so the supporting rack and the mobile member 4 is combined as one integrated member. The engaging section 41 is, not but limited to, a milling face column, a polygonal prism such as a triangle prism or a tetragon prism, so the engaging section 41 can be inserted and mounted on an object.

The substantial middle portion of the mobile member 4 is provided with a shaft ring 42, a shaft rod 43 is axially provided, and a curvy-shaped oil storing tank 44 for storing lubricating oil and providing a lubricating effect is provided on the surface. The feature of the mobile number 4 is that an oil sealing ring 45 whose outer diameter is slightly smaller than the inner diameter of the through hole 33 is provided between the shaft ring 42 and the shaft rod 43, in other words the rear portion of the shaft rod 43 is protrudingly provided with the oil sealing ring 45 having a larger outer diameter, and the outer diameter of the oil sealing ring 45 is 0.02 mm smaller than the inner diameter of the through hole 33 for easily passing through the through hole 33 and providing a function of anti-vibrating. The inner end of the oil sealing ring 45 of the shaft rod 43 adjacent to the through hole 33 is provided with a concave oil storing slot 46 for storing exceeding lubricating oil between the clamping ring 21 and the shaft rod 43, so an anti-leaking function is provided.

When assembling, the clamping ring 21, the rack sheet 22 and the latching tenon 24 of the inner shaft bushing 2 are respectively aimed to the shaft hole 13, the mounting slot 14 and the latching slot 15 and then respectively inserted to the shaft hole 13, the mounting slot 14 and the latching slot 15 with a mating tightening fashion; then the ring-shaped sheet 31 and the mounting sheet 32 of the end sealing sheet 3 are respectively mounted to the opening of the shaft hole 13 and the concave positioning slot 16 disposed below the shaft hole 13 and the protruding sections 34 provided at the periphery of the ring-shaped sheet 31 are received and fixed on the inner wall of the shaft hole 13, so the end sealing sheet 3 is retained at the opening end of the shaft hole 13; a jig is used to aim to the tenon slot/hole 25 of the rack sheet 22 inside the retaining member 1 and used to process a punch operation, so a concave section 18 is formed on the surface of the retaining member 1, and the deformed material is completely used to form a protruding tenon filled within each tenon slot/hole 25; lastly the shaft rod 43 of the mobile member 4 passes through the through hole 33 of the end sealing sheet 3 and is mounted in the clamping ring 21, and the oil sealing ring 45 provided at the rear portion of the shaft rod 43 is provided on the through hole 33 with a non-interfering fashion; by fixing the retaining member 1, the inner shaft bushing 2, the end sealing sheet 3 and the mobile member 4 the assembly of the rotation shaft provided by the present invention is completed and the end sealing sheet 3 provides an anti-vibrating function, the lubricating oil moving away from the shaft hole 13 is received by the concave oil storing tank 46 provided adjacently to the oil sealing ring 45 so an anti-leaking function is provided.

In the embodiment provided by the present invention, the end sealing sheet is tightly connected to the opening end of the shaft hole of the retaining member and to the concave positioning slot disposed below the shaft hole with fashions of interfering friction or mounting so the through hole of the end sealing sheet is at the position where the opening of the shaft hole of the retaining member is provided; the outer diameter of the rotation shaft provided by the present invention and the outer diameter of the oil sealing ring are both smaller than the inner diameter of the through hole of the end sealing sheet, so when connecting, the surface of the shaft rod is prevented from being damaged and the stability of the torque of the shaft rod and the clamping ring can be ensured; and interfering friction is not generated between the oil sealing ring and the inner side of the through hole, so the torque varying or over wearing can be avoided and it can be ensured that the torque is generated between the shaft rod and the inner shaft bushing and the service life of the rotation shaft is therefore increased; the whole end sealing sheet is mounted at the opening end of the shaft hole of the retaining member and at the concave positioning slot disposed below the shaft hole, so after the end sealing sheet is passed through by the shaft rod, advantages of anti-vibrating, anti-oil-leaking and tightly positioning are provided.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rotation shaft having function of anti-vibrating, comprises:
a retaining member having a sleeve, an shaft hole is axially formed on the sleeve, a mounting slot is radially extended from the shaft hole, the opening end of the shaft hole is adjacently connected to a concave positioning slot with a concave shape;
an inner shaft bushing having at least one hollow clamping ring, a rack sheet is radially extended from one end of the clamping ring, and an opening is provided by the other end of the clamping ring and the rack sheet, the clamping ring and the rack sheet are respectively connected to the shaft hole and the mounting slot;
an end sealing sheet, a mounting sheet is radially connected to a ring-shaped sheet of the end sealing sheet for being retained in the opening end of the shaft hole and the concave positioning slot, the ring-shaped sheet is axially provided with a through hole located at the opening end of the shaft hole and communicating with the clamping ring;
a mobile member, a shaft rod is axially extended from the mobile member and an oil sealing ring having an outer diameter larger than that of the shaft rod is protrudingly provided at the rear portion of the shaft rod, the shaft rod passes through the through hole and is covered by the clamping ring, and the outer diameter of the oil sealing ring is slightly smaller than the inner diameter of the through hole, so the oil sealing ring is provided on the through hole with a non-interfering fashion.

2. The rotation shaft having function of anti-vibrating as claimed in claim 1, wherein the lateral end of the mounting slot is provided with at least one latching slot and the surface of the rack sheet is protrudingly provided with a latching tenon with respect to the location of the latching slot for enhancing the mount and the connection between the mounting slot and the rack sheet.

3. The rotation shaft having function of anti-vibrating as claimed in claim 1 wherein the retaining member is provided with a connecting section and the mobile member is provided with an engaging section, the connecting section and the engaging section respectively have a jointing hole, the connecting section is a milling face column or a polygonal prism, and the engaging section is a milling face column or a polygonal prism.

4. The rotation shaft having function of anti-vibrating as claimed in claim 1, wherein the inner shaft bushing is cut by at least one rip slot, so at least two clamping rings are formed, the directions of the openings between the two clamping rings and the rack sheet can be the same or opposite.

5. The rotation shaft having function of anti-vibrating as claimed in claim 1, wherein the periphery of the end sealing sheet is provided with a plurality of protruding sections an interfere is formed between the protruding sections and the inner wall of the shaft hole so the end sealing sheet is fixed in the shaft hole.

6. The rotation shaft having function of anti-vibrating as claimed in claim 1, wherein the surface of the shaft rod is provided with a curvy shaped oil tank.

7. The rotation shaft having function of anti-vibrating as claimed in claim 1, wherein the surface of the rack sheet of the inner shaft bushing is provided with at least one tenon slot/hole, the surface of the retaining member is punched by a jig with respect to the locations of the tenon slots/holes so at least one concave section is formed on the surface of the retaining member and the deformed material is completely filled in each of the tenon slot/hole, so a protruding tenon having a column/strip shape is formed.

8. The rotation shaft having function of anti-vibrating as claimed in claim 1, wherein at least one end of the concave positioning slot is protrudingly provided with at least one connecting slot and the mounting sheet is protrudingly provided with a connecting pin with respect to the location of the connecting slot so the connecting pin is latched and received in the corresponding connecting slot.

9. The rotation shaft having function of anti-vibrating as claimed in claim 1 wherein the inner end of the oil sealing ring of the shaft rod adjacent to the through hole is provided with a concave oil storing tank.
